(19) United States
(12) Patent Application Publication
(10) Pub. No.: US 2004/0128544 A1
(43) Pub. Date: Jul. 1, 2004

(54) Method and system for aligning trust relationships with namespaces and policies

(75) Inventors: Maryann Hondo, Arlington, MA (US); Anthony Joseph Nadalin, Austin, TX (US); Ajamu Akinwunmi Wesley, Raleigh, NC (US)

Correspondence Address: Joseph R. Burwell, Law Office Of Joseph R. Burwell, P. O. Box 28022, Austin, TX, 78755-8022, US

(73) Assignee: INTERNATIONAL BUSINESS MACHINES CORPORATION, ARMONK, NY

(21) Appl. No.: 10/334,445

(22) Filed: Dec. 31, 2002

(51) Int. Cl. H04L 9/00

(52) U.S. Cl. 713/201

(57) ABSTRACT

A distributed trust infrastructure is presented that interfaces disparate trust models across trust domain boundaries and manages inter-domain and intra-domain trust relationships such that they are not reliant upon a single trust manager entity. A trust relationship between trust domains is represented by a trust link, which associates a namespace with a trust oracle, which is a service in a trust domain given responsibility to authoritatively resolve trust-related operations relative to the associated namespace. Trust links for a given trust domain are used by a trust link reference agent that is supported within the trust domain. The trust link reference agent is consulted for trust-related operations within its trust domain; after identifying the appropriate trust oracle for handling the trust-related operation, the trust-related operation is forwarded to the trust oracle for resolution. In addition, the trust links are associated with policies that guide the management of the trust links.

### BACKGROUND OF THE INVENTION

1. Field of the Invention

The present invention relates to an improved data processing system and, in particular, to a method and apparatus for multicomputer data transferring. Still more particularly, the present invention is directed to networked computer systems.

2. Description of Related Art

The Internet has greatly facilitated the exchange of information for many purposes. Many applications now incorporate Internet-related standards, thereby enabling enterprises to collaborate over the Internet while maintaining private networks. As Internet-connected applications have become more sophisticated and as enterprises have become more knowledgeable about the business advantages that can be realized by cooperating across the Internet, enterprises have shown a desire to increase the level of collaboration, particularly through web services that incorporate newly developed standards. Web services are self-contained, self-describing, modular applications that can be published, located, and invoked across the World Wide Web. Web services can perform a variety of simple functions or complicated business processes. Once a web service is deployed, other applications, including other web services, can discover and invoke the deployed service.

Enterprises generally desire to provide authorized users with secure access to web services or other types of protected resources in a user-friendly manner throughout a variety of networks, including the Internet. Although providing trust-related mechanisms reduces the risks of unauthorized access to web services, these same mechanisms may become barriers to user interaction with the web services. For example, many enterprises implement security for their web services by maintaining an independent registry of users and using basic authentication challenges. In this manner, an enterprise maintains its own set of trust relationships with its own set of users and establishes trust with its users through the use of authentication protocols.

However, users generally desire the ability to jump from interacting with one web service to another web service without regard to the electronic trust relationship barriers that protect each particular system supporting those web services. As users get more sophisticated, they expect web services to collaborate, particularly with respect to trust-related processes, so that burdens on the user are reduced. For example, a user might assume that once he or she has been authenticated by some web service, the authentication should be valid throughout the user's working session, or at least for a particular period of time, without regard to the various computer architecture boundaries that are almost invisible to the user. Enterprises generally want to fulfill these expectations in the operational characteristics of their deployed web services, not only to placate users but also to increase user efficiency, whether the user efficiency is related to employee productivity or customer satisfaction.

More specifically, enterprises must maintain their own trust domains; as mentioned above, each enterprise maintains its own set of trust relationships with its own set of users or trusted entities, which may include other enterprises or systems. Users expect more user-friendliness and low or infrequent barriers to movement from one web service in one domain to another web service on another domain without regard to the barriers that protect each particular domain, i.e., without regard to trust domain boundaries. Subjecting a user to multiple trust-related challenges in a short time frame may significantly affect the user's efficiency.

Hence, enterprises that are implementing collaborative web services have a goal of interfacing those web services across trust domain boundaries to reduce unnecessary barriers at those boundaries. Inspiration for these efforts can be found in various techniques that have been used to reduce authentication burdens on users and computer system administrators in legacy environments. These techniques are generally described as “single-sign-on” (SSO) processes because they have a common purpose: after a user has completed a sign-on operation, i.e. after the user has been authenticated, the user is subsequently not required to perform another authentication operation; the user is required to complete only one authentication process during a particular user session. Such single-sign-on solutions have been successful when implemented within a given enterprise, and in limited cases, when implemented between enterprises in homogeneous environments in which there are pre-established business agreements between participating enterprises. These business agreements are used, in part, to establish trust and to limit and define how information is transferred in a trusted manner between enterprises. These business agreements also include technological agreements on rules on how to translate, or map, user identities from one enterprise to another, and how to transfer between participating enterprises any information that is used to vouch for users or that is used for other user-specific operations.

In other words, an enterprise that participates in one of these business environments must adhere to a predefined trust model, thereby restricting its information technology (IT) infrastructure. However, web services are being assembled within the World Wide Web, which remains a vigorously open and heterogeneous environment. An enterprise that partners with another enterprise through one or more web services needs to retain control over its data, its policies, and its interactions with other partners. At the same, an enterprise needs a web service architecture that supports freedom of choice in trust establishment mechanisms and technology, freedom of policy around trust relationships, and cooperation between disparate trust models.

Therefore, it would be advantageous to have a distributed trust infrastructure for providing interfaces with disparate trust models across trust domain boundaries and for managing inter-domain and intra-domain trust relationships in which the trust infrastructure is not reliant upon a single trust manager entity. It would be particularly advantageous to manage the trust infrastructure in a manner that provides synchronization with policies.

### SUMMARY OF THE INVENTION

A method, system, apparatus, or computer program product is presented for a distributed trust infrastructure for providing interfaces with disparate trust models across trust domain boundaries and for managing inter-domain and intra-domain trust relationships in which the trust infrastructure is not reliant upon a single trust manager entity. Trust relationships between trust domains are represented through the use of trust links. Each trust link associates one or more namespaces with a trust oracle, which is a service in a trust domain given responsibility to authoritatively resolve trust-related operations that are relative to the associated namespaces. The trust links for a given trust domain are stored within a database that is maintained by a trust link reference agent that is supported within the trust domain. A data processing entity within a trust domain refers a trust-related operation to the trust link reference agent, which determines the appropriate trust oracle for handling the trust-related operation; the trust-related operation is then forwarded to the trust oracle for resolution. In addition, the trust links are associated with policies that guide the management of the trust links.

### BRIEF DESCRIPTION OF THE DRAWINGS

The novel features characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 depicts a block diagram that shows a typical web service transaction;

FIG. 3 depicts a block diagram that shows a set of components that may be used within a trust domain that supports a trust link infrastructure in accordance with the present invention;

FIG. 4 depicts a block diagram that shows a set of components that may be implemented across multiple domains that support a trust link infrastructure in accordance with the present invention;

FIG. 5 depicts a block diagram that shows an example of multiple namespaces containing web services, trust link reference agents, trust oracles, and a trust link management agent;

FIG. 6 depicts a flowchart that shows a summary for the management of the lifecycle of a trust link;

FIG. 7 depicts a flowchart that shows a process for generating a trust link in accordance with an embodiment of the present invention;

FIG. 8 depicts a flowchart that shows a process in which a trust link is used to locate a trust oracle that assists in the continuation of a pending transaction in accordance with an embodiment of the present invention;

FIG. 9 depicts a flowchart that shows a process that is completed by a trust link reference agent in accordance with an embodiment of the present invention; and

FIG. 10 depicts a flowchart that shows a process that is completed by a trust oracle in accordance with an embodiment of the present invention.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to presenting the present invention in more detail.

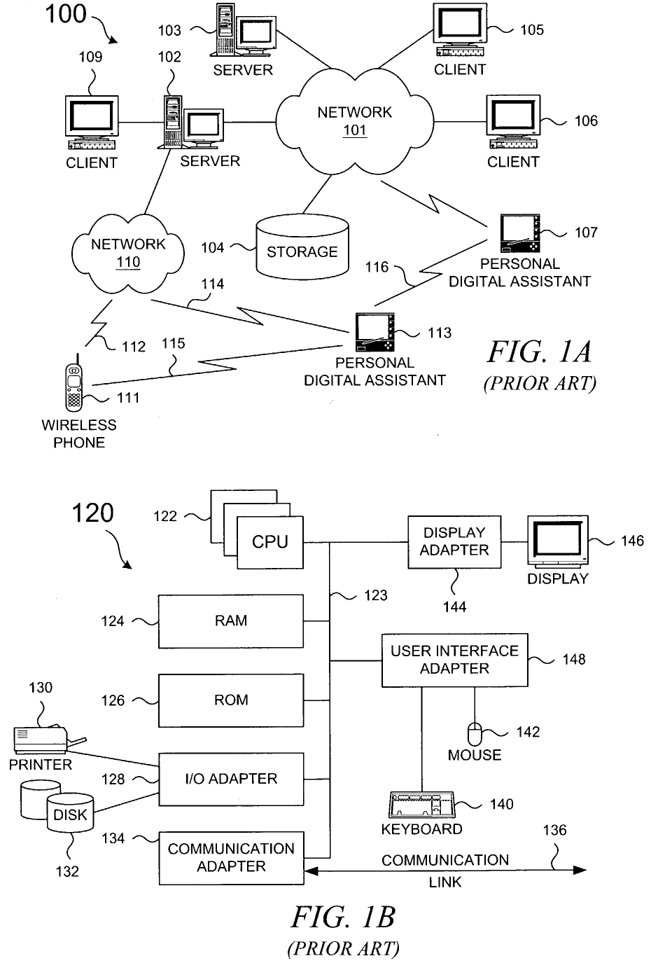

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B. More specifically, though, the present invention is directed to managing trust relationships within a web service architecture, as described in more detail below with respect to the remaining figures.

In a manner similar to prior art systems, the web services that are depicted in the following figures may operate through the use of well-known specifications, such as HTTP, XML, SOAP (Simple Object Access Protocol), UDDI (Universal Description, Discovery, and Integration), WSDL (Web Service Definition Language), and other specifications. It should be noted that although the trust link infrastructure of the present invention may be configured to interoperate with web services, the present invention may be integrated within other types of data processing systems without affecting the scope of the present invention. For example, rather than interoperating with web services, the present invention may interoperate with other types of applications or entities that generally provide access to resources, particularly protected resources. A protected resource is a resource (an application, an object, a document, a page, a file, executable code, or other computational resource, communication-type resource, etc.) that is only accessed or retrieved if the requester is both authenticated and authorized. In addition, the trust link infrastructure that is shown within the figures might represent only a few components that are a portion of a larger data processing infrastructure with additional components.

It should also be noted that the content of any trust-related information that is employed within the present invention may vary without affecting the scope of the present invention; any transferred information may be encrypted and/or digitally signed to protect the confidentiality and integrity of the data. Examples of trust-related information may include security information such as username/password combinations, digital certificates, security tokens, security assertions, or any other information that is considered to be related to trust-related operations or trust-related processes. For example, a requester's trust-related information may include an X.509 public key digital certificate, which contains the requester's trust-related identifier in the form of a subject name within the digital certificate. As another example, a Security Assertion Markup Language (SAML) assertion is an example of a possible assertion format that may be used within the present invention, particularly a subject identifier assertion. SAML has been promulgated by the Organization for the Advancement of Structured Information Standards (OASIS), which is a non-profit, global consortium. SAML is described in “Assertions and Protocol for the OASIS Security Assertion Markup Language (SAML)”, Committee Specification 01, 05/31/2002.

It should also be noted that any trust-related operations that are performed within the present invention may vary without affecting the scope of the present invention. Referring again to the example of a digital certificate as trust-related information, a trust-related operation may include verifying a digital signature using the signer's public key certificate. As another example, a trust-related operation may include a translation of a security assertion from a first assertion data format to a second assertion data format. As yet another example, a trust-related operation may include a mapping of a first user identifier that is valid in a first trust domain to a second user identifier that is valid in a second trust domain. As a further example, a trust-related operation may include a security challenge, e.g., a typical username/password challenge.

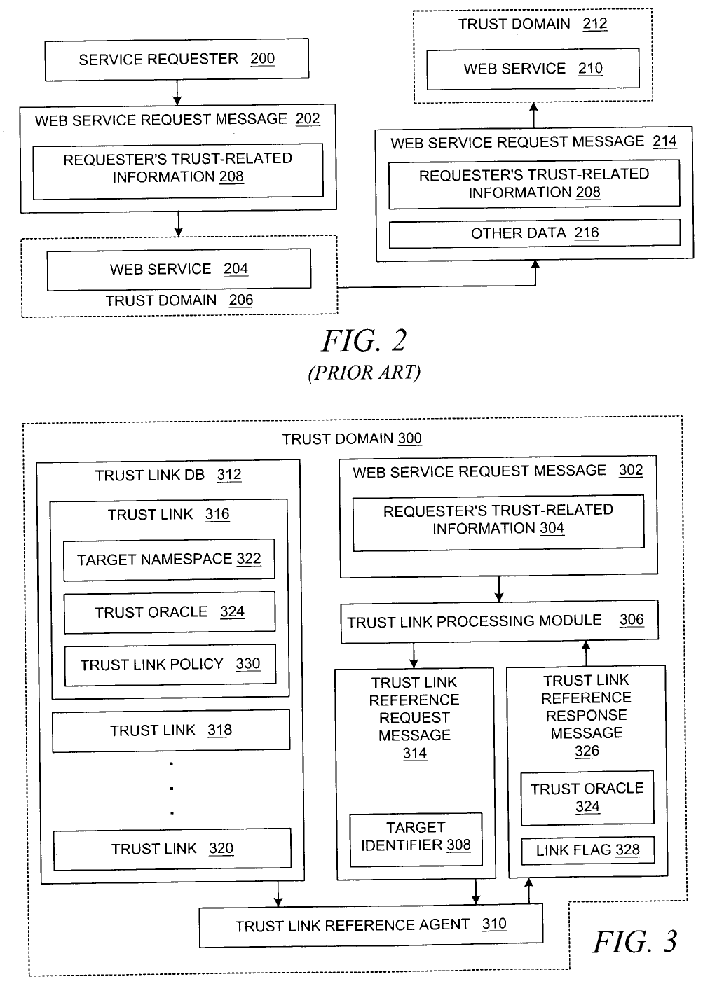

With reference now to FIG. 2, a block diagram depicts a typical web service transaction. Service requester 200 sends web service request message 202 to web service 204 in trust domain 206. Web service request message 202 contains requester's trust-related information 208. Web service request message 202 may be formatted in accordance with the requirements of the web service environment. It should also be noted that although the examples herein depict the transfer of information through messages, the present invention may be implemented to transfer information through appropriate application programming interfaces (APIs) or through some other means.

At some subsequent point in time, web service 204 determines that it needs to invoke functionality at web service 210 in trust domain 212 in order to complete its pending transaction for service requester 200. Web service 204 sends web service request message 214 to web service 210 in trust domain 212. Web service request message 214 contains requester's trust-related information 208 and possibly other web service data 216. In this manner, a preliminary transaction may spawn downstream transactions that are accompanied by trust-related information from the original requester that is forwarded, either modified or unmodified, from web service to web service.

With reference now to FIG. 3, a block diagram depicts a set of components that may be used within a trust domain that supports a trust link infrastructure in accordance with the present invention. In a manner similar to FIG. 2, trust domain 300 processes web service request message 302, which contains requester's trust-related information 304. In contrast to FIG. 2, web service request message 302 originates within trust domain 300 rather than external to trust domain 300; this difference from FIG. 2 emphasizes the fact that web service request messages or other types of resource requests may originate either inside or outside a trust domain without affecting the processing of the present invention. In addition, web service request message 302 is shown as being processed by trust link processing module 306 rather than by a web service; this difference from FIG. 2 emphasizes the fact that the functionality of the present invention may be integrated into any application runtime environment in many different forms of software (or hardware) on many different software platforms without affecting the scope of the present invention.

In a manner similar to FIG. 2, at some subsequent point in time, a web service or other entity in trust domain 300 determines that the pending transaction requires additional processing at another web service or entity. Moreover, the web service is aware that it must forward the requester's trust-related information to the other web service. This awareness may arise from the published requirements of the other web service in a web service registry or from some other exchange of information.

In addition, the web service may be aware that the other web service resides in a different trust domain; in other words, an inter-domain transfer of trust-related information is required. Hence, the web service cannot assume that it has an inherent trust relationship with the other web service based on the fact that both web services do not reside in the same trust domain. However, it should be noted that the present invention is also operable in scenarios in which only an intra-domain transfer of trust-related information is required.

Trust relationships have inherent characteristics, e.g., that a party to a trust relationship does not violate the integrity and confidentiality of information that has been received from the other party to the trust relationship. In other words, a trust relationship carries a presumption that parties to the trust relationship only share confidential information with other parties outside of the trust relationship in accordance with constraints defined by the trust relationship; it should be noted, though, that trust agreements may have multiple parties.

In FIG. 2, web service 204 was assumed to have a trust relationship with web service 210 such that web service 204 could forward the requester's trust-related information to web service 210 without violating the trust relationship. In other words, the need for the requester's trust-related information at web service 210 is within the scope of the trust relationship between web service 204 and web service 210. In this scenario, it may be assumed that web service 204 and web service 210 adhere to the same trust model, i.e. they operate in a homogeneous environment. In this manner, each web service understands the trust-related requirements of the other web service or web services, particularly with respect to the handling of any trust-related information.

The present invention, though, is intended to operate in a heterogeneous environment in which a first web service cannot assume that a second web service adheres to the same trust model as the first web service. The present invention resolves these competing interests by allowing the first web service to assume that when a trust relationship has been defined between it and a second web service (or any web services involved since there may be many intermediaries), an entity exists that bridges the trust models of the two web services, if necessary; that entity is herein termed as a trust oracle. As illustrated in more detail further below, a trust oracle is a service, possibly a web service, that is trusted by a trust domain to authoritatively resolve trust-related operations relative to an associated namespace.

Referring again to FIG. 3, at some subsequent point in time during the processing of a transaction, trust link processing module 306 in trust domain 300 determines that the pending transaction requires additional processing by another entity. Trust link processing module 306 possesses some form of target identifier 308 that is associated with the other entity; target identifier 308 may be an identifier for a web service, a DNS (Domain Name System) identifier, an IP address, a URI (Uniform Resource Identifier), or some other type of identifier that has been obtained in some manner through its associated with the target web service or target entity. For example, target identifier 308 may be an identifier for a web service, but in a related manner, target identifier 308 may be an identifier for a firewall, a reverse proxy server, a load-balancing server, or some other entity that is associated with the web service. In other words, trust link processing module 306 minimally knows that it has an identifier that is associated with a target resource to which it is needs to transfer trust-related information in a trustworthy manner.

Rather than requiring trust link processing module 306 to maintain its own information about trust relationships that may exist between itself (or more appropriately, trust domain 300 in which it resides) and other entities, trust link processing module 306 defers to trust link reference agent 310. With reference to trust link database 312, trust link reference agent 310 determines on behalf of trust link processing module 306 whether a trust relationship exists between trust domain 300 and the trust domain that is associated with target identifier 308.

In order to obtain the identity of the trust oracle that is required to continue the processing of the pending transaction, trust link processing module 306 sends a trust link reference request message 314 containing target identifier 308 to trust link reference agent 310. Trust link reference agent 310 uses target identifier 308 to search through trust link records or data structures 316-320 that are stored within trust link database 312.

Each trust link in trust link database 312 contains an association between a target namespace and a trust oracle; an association represents a direct trust relationship. During the search operation, trust link reference agent 310 compares target identifier 308 against the target namespaces in the trust links to determine if a target namespace subsumes target identifier 308. The manner in which the comparison is performed depends upon the type of namespace that is implemented. Target namespace 322 may be represented within a trust link as an expression that is evaluated to determine the target namespace; alternatively, a simple identifier represents the target namespace. Any appropriate namespace convention may be used within the present invention. Moreover, depending on the type of namespace, it is possible that many target namespaces may subsume the target identifier; in such cases, it may be assumed that an appropriate algorithm exists for determining a best choice amongst many candidate target namespaces. For example, in the DNS system, one can determine which of two names identifies a more specific pathname. In this manner, the existence of a trust relationship is aligned with the use of namespaces within a web services environment.

As mentioned above, each trust link in the trust link database contains an association between a target namespace and a trust oracle. Assuming that a subsuming namespace is located, such as target namespace 322 in trust link 316, then identifier 324 for the trust oracle associated with target namespace 322 is retrieved. Trust link reference agent 310 returns trust link reference response message 326 containing a response indicating a trust link has been established (link-exists flag 328) and indicating a trust oracle identifier 324 to the trust link processing module if more contact with the target oracle is required. If no subsuming target namespace is located for the target identifier during the search of the trust links, then it may be assumed that there is no predefined trust relationship between trust domain 300 and the trust domain that contains target identifier 308, and some type of status would be returned to trust link processing module 306.

Each trust link in the trust link database also contains an association between a target namespace and a policy, herein termed a trust link policy. For example, trust link 316 contains trust link policy 330. The use of a trust link policy is described in more detail further below.

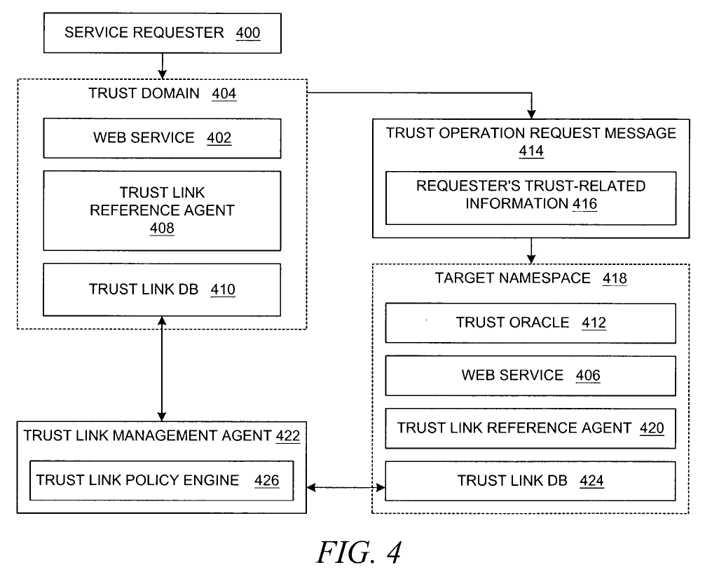

With reference now to FIG. 4, a block diagram depicts a set of components that may be implemented across multiple domains that support a trust link infrastructure in accordance with the present invention. In contrast to FIG. 3, which illustrates some components within a trust domain, FIG. 4 illustrates some of the same components along with additional components that reside in different trust domains or namespaces; in addition, FIG. 4 illustrates some of the data flow that occurs after a web service has obtained an identifier for a trust oracle as shown in FIG. 3.

In a manner similar to FIG. 3, service requester 400 interacts with web service 402 in trust domain 404 to complete a transaction. Web service 402 determines that it needs to invoke functionality at web service 406 and proceeds to contact trust link reference agent 408 to obtain an identifier from trust link database 410 for trust oracle 412 that is associated with web service 406.

FIG. 3 did not illustrate what a web service should do with an identifier for a trust oracle, which is shown in FIG. 4. Web service 402 sends trust operation request message 414 containing the service requester's trust-related information 416 to trust oracle 412 in target namespace 418. In this manner, web service 402 forwards the service requester's trust-related information in a trustworthy manner to target namespace 418 (specifically, trust oracle 412) in keeping with the requirements of a trust relationship between trust domain 404 and target namespace 418, which may also define a trust domain or may be contained within a different trust domain. Trust oracle 412 may be trusted by web service 402 to eventually provide any required information to web service 406. Web service 406 has access to trust link reference agent 420 for accomplishing similar transfers of information.

A trust oracle is a service that is trusted by a trust domain to authoritatively resolve trust-related operations relative to the associated namespace. The target namespace or namespaces in a trust link may or may not fall within the trust domain of the trust link's associated trust oracle. If they do, then the trust oracle is trusted to directly resolve a requested trust-related operation. Otherwise, the trust oracle is trusted to indirectly resolve a requested trust-related operation via referrals or chaining. In other words, a trust link defines a trust oracle that can be relied upon to answer questions about namespaces; it does not matter if the trust oracle answers questions from data that it maintains or by conferring with another trust oracle.

In addition, trust link management agent 422 manages the trust links between trust domains and/or web services. Most transactions involve a transfer of information in two directions, so each party to a trust relationship needs to be able to find each other's inbound and outbound trust oracle. Trust link management agent 422 ensures that appropriate trust links are stored in the respective trust link databases 410 and 424.

Moreover, trust link management agent 422 employs trust link policy engine 426 to apply a trust link policy to its associated trust link. Various parameters or properties about a trust link may also be stored within the trust link database entry, and these parameters may be used to evaluate the trust link's policy. A trust link may be static or dynamic indicating whether the trust link was manually established out-of-band or dynamically established in-band, e.g., through the use of electronic TPAs (Trading Partner Agreements) or other e-commerce mechanisms. A trust link may also be limited by policy such as by session, task, or time, e.g., between two e-commerce enterprises for the duration of a particular transaction, or it may be persistent or unlimited, e.g., between two long-term trading partners. In addition, a trust link may be dependent such that it is subservient to and dependent upon another trust link, and if a trust link within its trust chain is removed or compromised, the trust link might also be removed; otherwise, the trust link might be independent of other trust links. These and other considerations may be controlled for a particular trust link through its associated trust policy. In this manner, the existence of a trust relationship is aligned with the use of policies within a web services environment.

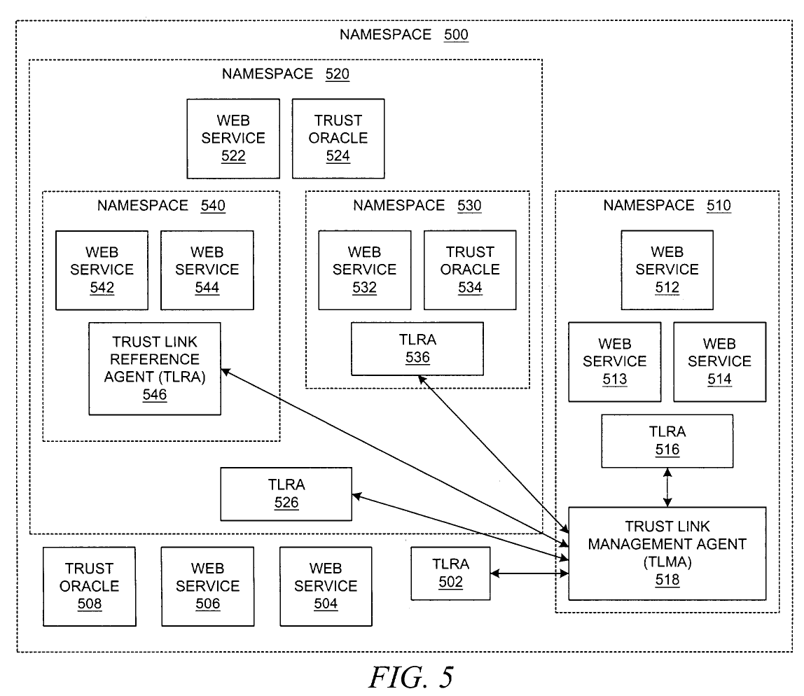

With reference to FIG. 5, a block diagram depicts an example of multiple namespaces containing web services, trust link reference agents, trust oracles, and a trust link management agent. Within namespace 500 resides trust link reference agent 502, web services 504 and 506, and trust oracle 508. Within namespace 510 resides web services 512, 513, and 514, along with trust link reference agent 516 and trust link management agent 518. Within namespace 520 resides web service 522 and trust oracle 524 along with trust link reference agent 526. Within namespace 530 resides web services 532 and 534 along with trust link reference agent 536. Within namespace 540 resides web services 542 and 544 along with trust link reference agent 546.

In a hierarchical fashion, namespace 500 subsumes namespace 510 and namespace 520, which subsumes namespace 530 and namespace 540. Each of these namespaces contains at least one web service and may be named as a target namespace within a trust link, but not each of these namespaces supports a trust oracle; a trust oracle may support multiple namespaces, and a trust oracle may be able to indirectly resolve trust-related operations for namespaces in which it does not reside.

Each namespace may support zero or more trust link management agents. Trust link management agent 518 creates, modifies, or destroys trust links as necessary or as requested.

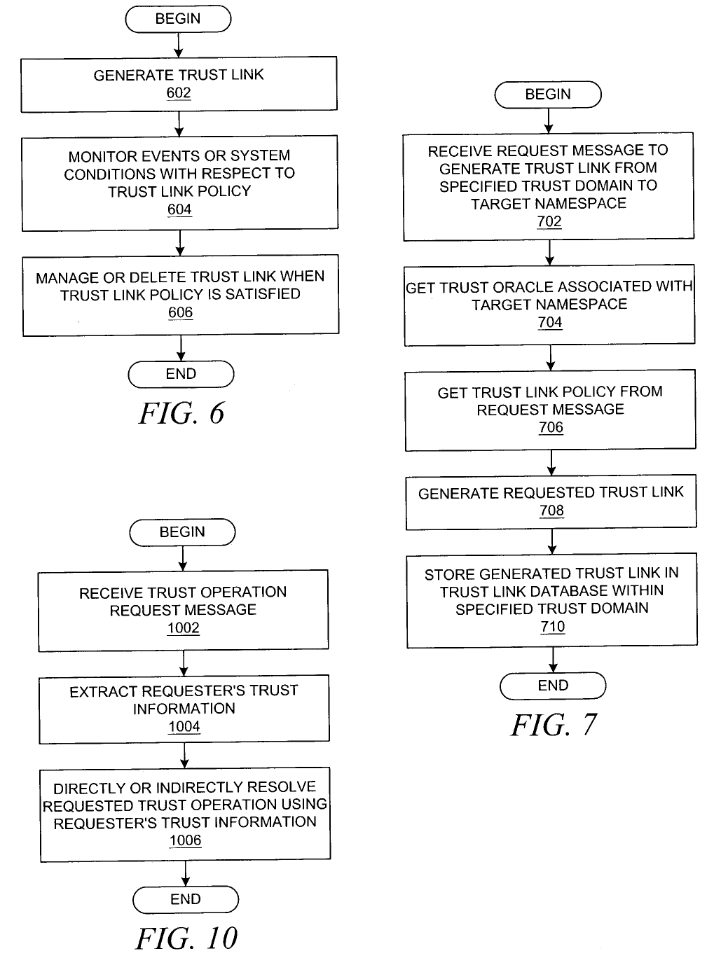

With reference now to FIG. 6, a flowchart depicts a summary for the management of the lifecycle of a trust link. The process begins when a trust link is generated (step 602). An entity, such as a trust link management agent, monitors events or system conditions with respect to the previously generated trust link in accordance with its trust link policy (step 604). If the trust policy conditions are satisfied, the trust link is managed or modified in some manner, possibly by being deleted (step 606), thereby concluding the process.

With reference now to FIG. 7, a flowchart depicts a process for generating a trust link. FIG. 7 shows further detail for step 602 in FIG. 6. The process begins with an entity, such as a trust link management agent, receiving a request message to generate a trust link from a specified trust domain to a target namespace (step 702). The request to generate a trust link may originate from a web service or other application that is responsible for configuring a transaction infrastructure in accordance with an electronic contract that has been exchanged between two enterprises. The trust oracle that is associated with the target namespace is determined (step 704), e.g., by referencing some configuration information. A trust link policy is then retrieved (step 706), possibly from the request message if it accompanied the request. The requested trust link is then generated (step 708) and stored within a trust link database within the specified trust domain (step 710), and the process is concluded.

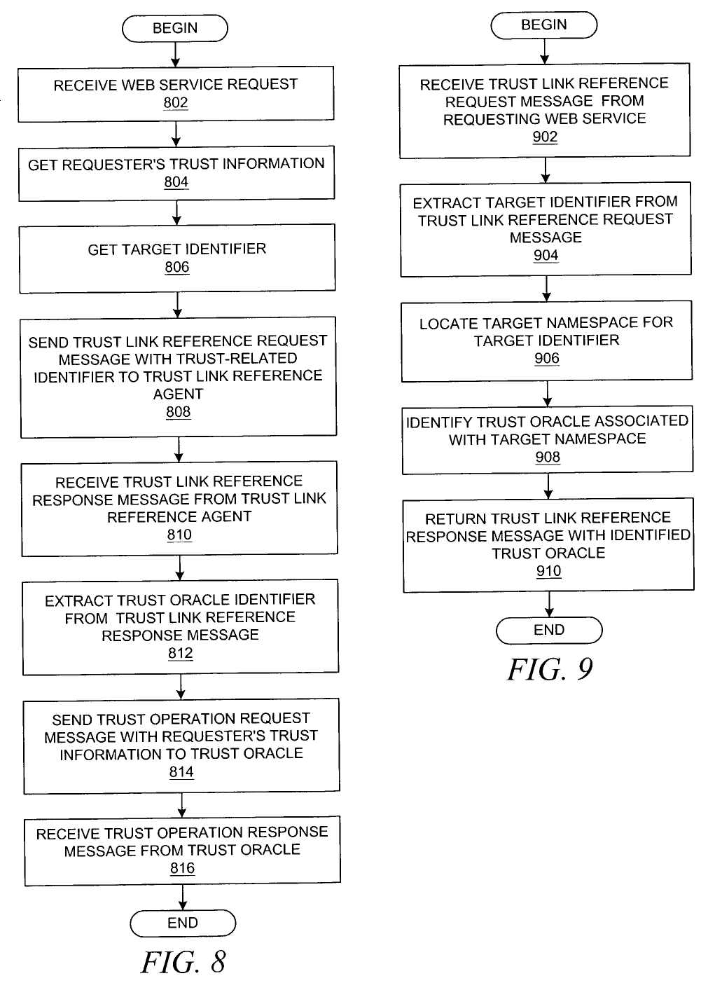

With reference now to FIG. 8, a flowchart depicts a process in which a trust link is used to locate a trust oracle that assists in the continuation of a pending transaction in accordance with an embodiment of the present invention. The process begins when a web service receives a web service request message (step 802). The web service extracts the requester's trust information from the web service request message (step 804). A target identifier for another web service is obtained (step 806), and a trust link reference request message with the target identifier is sent to a trust link reference agent (step 808). At some later point in time, a trust link reference response message is received (step 810), and an identifier for a trust oracle is extracted from the response message (step 812); the web service may perform other operations during the time interval between sending the request and receiving the response. A trust operation request message with the requester's trust-related information is then sent to the trust oracle (step 814), and at some later point in time, a trust operation response message is received (step 816), thereby concluding the process.

With reference now to FIG. 9, a flowchart depicts a process that is completed by a trust link reference agent in accordance with an embodiment of the present invention. FIG. 9 depicts some of the processing that occurs at a trust link reference agent during the time period between steps 808 and 810 in FIG. 8. The process begins when a trust link reference agent receives a trust link reference request message from a requesting web service (step 902), after which the target identifier is extracted from the request message (step 904). A trust link database is searched for a target namespace that subsumes the target identifier (step 906), and an identifier for a trust oracle associated with the target namespace is obtained (step 908). The trust link agent then returns a trust link reference response message which includes an identifier for the identified trust oracle (step 910), and the process is concluded.

With reference now to FIG. 10, a flowchart depicts a that is completed by a trust oracle in accordance with an embodiment of the present invention. FIG. 10 depicts some of the processing that occurs at a trust oracle during the time period between steps 814 and 816 in FIG. 8. The process begins when the trust oracle receives a trust operation request message (step 1002), which requests that the trust oracle perform some type of trust-related operation on the requester's trust-related information that is extracted from the request message (step 1004). The trust oracle then directly or indirectly resolves the requested trust operation using the requester's trust-related information (step 1006), and the process is concluded, possibly after returning a response message to the requester.

The advantages of the present invention should be apparent in view of the detailed description that is provided above. When a web service performs operations for a transaction on behalf of a user, the web service may need to interact with other web services, and during this interaction, a trust-related operation may be required. For example, one of the other web services may require the validation of some proof-of-possession, such as authentication information for the user, before it will perform a service that is requested by the original web service on behalf of the user. In the prior art, these types of requirements have forced enterprises to operate in a homogeneous environment in which the enterprises format and process authentication information or other trust-related information in the same manner.

In the present invention, a distributed trust infrastructure allows an enterprise to manage trust relationships between one or more of its trust domains and one or more trust domains of other enterprises in a heterogeneous environment. A trust relationship between trust domains is represented by a trust link, which associates one or more namespaces with a trust oracle, which is a service that is trusted by a trust domain to authoritatively resolve trust-related operations relative to the associated namespace. Trust links for a given trust domain are used by a trust link reference agent that is supported within the trust domain. The trust link reference agent is consulted for trust-related operations within its trust domain; after identifying the appropriate trust oracle for handling the trust-related operation, the trust-related operation is forwarded to the trust oracle for resolution.

In this manner, different trust oracles may employ different trust models within different trust domains. Other data processing entities within a trust domain are not burdened with the responsibility of mapping or translating information between trust models; the trust oracle within a trust domain is relied upon to resolve any trust-related questions that are associated with the processing that is being performed by the data processing entities within the same trust domain, such as a web service within the trust domain.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for processing information within a data processing system, the method comprising:
creating a trust link between trust domains, wherein a trust link associates a trust domain with a namespace containing a trust oracle, wherein the trust oracle resolves requests for trust-related operations; and
managing the trust link in accordance with a policy associated with the trust link.

2. The method of claim 1 further comprising:
generating a data structure comprising an expression for the namespace and an identifier for the trust oracle; and
storing the generated data structure in a database within the trust domain.

3. The method of claim 2 further comprising:
obtaining an identifier associated with a trust-related operation;
searching the database using the identifier associated with the trust-related operation to locate a namespace containing the identifier associated with the trust-related operation;
identifying a trust oracle associated with the located namespace; and
sending the trust-related operation to the identified trust oracle.

4. The method of claim 3 wherein the trust-related operation is a web service request message.

5. The method of claim 1 wherein the trust link represents a trust relationship between two trust domains.

6. The method of claim 1 wherein the trust link is managed by a trust link management unit that manages corresponding trust links between trust domains.

7. The method of claim 1 further comprising:
monitoring conditions specified by the policy associated with the trust link;
modifying the trust link when conditions specified by the policy associated with the trust link are satisfied.

8. An apparatus for processing information within a data processing system, the apparatus comprising:
means for creating a trust link between trust domains, wherein a trust link associates a trust domain with a namespace containing a trust oracle, wherein the trust oracle resolves requests for trust-related operations; and
means for managing the trust link in accordance with a policy associated with the trust link.

9. The apparatus of claim 8 further comprising:
means for generating a data structure comprising an expression for the namespace and an identifier for the trust oracle; and
means for storing the generated data structure in a database within the trust domain.

10. The apparatus of claim 9 further comprising:
means for obtaining an identifier associated with a trust-related operation;
means for searching the database using the identifier associated with the trust-related operation to locate a namespace containing the identifier associated with the trust-related operation;
means for identifying a trust oracle associated with the located namespace; and
means for sending the trust-related operation to the identified trust oracle.

11. The apparatus of claim 10 wherein the trust-related operation is a web service request message.

12. The apparatus of claim 8 wherein the trust link represents a trust relationship between two trust domains.

13. The apparatus of claim 8 wherein the trust link is managed by a trust link management unit that manages corresponding trust links between trust domains.

14. The apparatus of claim 8 further comprising:
means for monitoring conditions specified by the policy associated with the trust link;
means for modifying the trust link when conditions specified by the policy associated with the trust link are satisfied.

15. A computer program product in a computer readable medium for use in processing information within a data processing system, the computer program product comprising:
means for creating a trust link between trust domains, wherein a trust link associates a trust domain with a namespace containing a trust oracle, wherein the trust oracle resolves requests for trust-related operations; and
means for managing the trust link in accordance with a policy associated with the trust link.

16. The computer program product of claim 15 further comprising:
means for generating a data structure comprising an expression for the namespace and an identifier for the trust oracle; and
means for storing the generated data structure in a database within the trust domain.

17. The computer program product of claim 16 further comprising:
means for obtaining an identifier associated with a trust-related operation;
means for searching the database using the identifier associated with the trust-related operation to locate a namespace containing the identifier associated with the trust-related operation;
means for identifying a trust oracle associated with the located namespace; and
means for sending the trust-related operation to the identified trust oracle.

18. The computer program product of claim 17 wherein the trust-related operation is a web service request message.

19. The computer program product of claim 15 wherein the trust link represents a trust relationship between two trust domains.

20. The computer program product of claim 15 wherein the trust link is managed by a trust link management unit that manages corresponding trust links between trust domains.

21. The computer program product of claim 15 further comprising:
means for monitoring conditions specified by the policy associated with the trust link;
means for modifying the trust link when conditions specified by the policy associated with the trust link are satisfied.
